(19) United States
(12) Patent Application Publication
(10) Pub. No.: US 2009/0225922 A1
(43) Pub. Date: Sep. 10, 2009

(54) Neutron flux source and use thereof

(76) Inventor: David S. Koltick, Lafayette, IN (US)

Correspondence Address: Thomas A. Ladd, 5802 N. Dearborn St., Indianapolis, IN, 46220, US

(21) Appl. No.: 12/157,416

(22) Filed: Jun. 10, 2008

Related U.S. Application Data
(63) Continuation-in-part of application No. 10/440,038, filed on May 16, 2003, now abandoned.
(60) Provisional application No. 60/937,028, filed on Jun. 25, 2007.

(51) Int. Cl. G21G 1/06

(52) U.S. Cl. 376/159; 376/158

(57) ABSTRACT

The patent specification and claims disclose a neutron flux source supplying both monoenergentic neutrons and a spectrum of neutron energies similar to the neutron emission of ²⁵²Cf. The neutron flux source is applied to interrogate unknown materials in closed containers for classification of the contents.

This application claims priority from U.S. Provisional patent application 60/937,028 filed Jun. 25, 2007 and is a continuation-in-part application from U.S. utility application Ser. No. 10/440,038.

### BACKGROUND

Neutron projectiles upon impact with, or capture by, nuclei cause excitement of the nucleus often resulting in gamma-ray emission, which can be accompanied by one of the following: emission of one or more nuclear particles by the excited nucleus, fission or division of the nucleus into two elements. The gamma radiation emitted by neutron impacted nuclei is, in most cases, specific to each element. Detection of the emitted gamma-ray by detectors for that purpose, and appropriate spectral analysis thereof may determine the elements present in a neutron irradiated sample. Monoenergetic neutrons are not as effective as a broad energy spectrum of neutrons in causing neutron capture on the nuclei of all elements. Neutron interactions useful for production of gamma-ray signatures of elements more easily excited by capture of neutrons by the nucleus of an element and those more easily excited by inelastic scattering of neutrons by the nucleus are addressed herein. Neutron energies required to induce nuclear excitations which result in gamma-ray emission at room temperature range from 0.025 eV for capture to 6.5 MeV or greater for inelastic scattering. There is disclosed and claimed herein a broad band neutron energy source initiated by a mono-energetic neutron source.

Neutron excitation of elements provides gamma radiation nearly unique for each element. Elemental gamma-ray lines can be considered distinguishable if their energy difference is greater than the energy resolution of the gamma-ray detector. The contents of a container may be classified by interrogation of the container by neutrons. Resulting gamma radiation will identify the elemental contents of the container and their elemental ratios can be found. Knowledge of the elements present and their ratios does not differentiate between a mixture and a chemical compound having the elements and ratios identified by gamma spectra. Nonetheless neutron interrogation can provide the user a basis to determine if a container may contain contraband contents or if the possibility of contraband may be eliminated.

### BRIEF DESCRIPTION OF THE DRAWINGS

FIG. 1 is a histogram showing a comparison of signals obtained using the generator in pulsed and continuous mode. When using pulsed mode, fast signals, such as lead, disappear.

FIG. 2 is a histogram of the emitted neutron energy for ²³⁸U and ²⁵²Cf.

FIG. 3 shows a shaped reflector/amplifier for suitable for generating thermal neutrons in connection with a D-T neutron generator.

FIG. 4 shows a Monte Carlo calculation of the reflected neutrons per impacting neutrons for reflected neutrons returning across the top surface in the energy range from 0 keV to 1 keV as a function of reflector thicknesses for reflector materials lead, carbon iron, uranium, beryllium, polyethylene and tungsten.

FIG. 5 follows FIG. 4 for the energy range 1 keV to 100 keV.

FIG. 6 follows FIG. 4 for the energy range 100 keV to 1 MeV.

FIG. 7 follows FIG. 4 for the energy range 1 MeV to 6 MeV.

FIG. 8 follows FIG. 4 for the energy range 6 MeV to 14 MeV

FIG. 9 is a consolidation of the data for FIGS. 4-8 for the energy range 0 keV to 14 MeV.

FIG. 10 shows a classification example of two materials, each composed of three elements.

FIG. 11 is a histogram showing the nitrogen signal detection with and without the uranium neutron reflector.

FIG. 12 is a histogram showing the hydrogen signal detection using Uranium, Lead, and Graphite as neutron reflectors compared to the no reflector case.

FIG. 13 illustrates a passenger baggage interrogation system incorporating a D-T neutron generator and thermalizing neutron reflector for 14 MeV neutrons.

FIG. 14 is a comparison of the hydrogen signal using the uranium reflector with and without a 2 liter bottle of water. When the bottle is not present, there is no hydrogen signal in the background.

FIG. 15 shows a conceptual example of the reduced elemental hyperspace, with three separated groups of materials.

FIG. 16 shows an example of organophosphate insecticides separating into three groups within the reduced elemental hyperspace.

FIG. 17 shows an example schematic of a computer program used to automate the classification algorithm and mechanical tasks required in a neutron interrogation system.

### DESCRIPTION OF THE INVENTION

Interrogation of a material by neutrons provides an emitted gamma-ray spectrum that facilitates classification of multiple elements of the material. Neutrons excite the nuclei of elements by at least two methods: (1) Fast neutrons, which most probably cause fast neutron reactions, or (n,n′) inelastic scattering reactions, in which the incoming neutron is not absorbed. These reactions have large cross sections, or high probability of occurrence, with neutron energy greater than 100 keV. (2) Slow neutrons, which cause neutron capture reactions, tend to have large cross sections, or high probability of occurrence, for neutrons with energy less than 100 keV. Because neutron capture events are due to neutrons that have been slowed due to multiple collisions with elemental nuclei in the material, capture reactions are delayed tens to hundreds of microseconds after the neutron's production by the generator.

The elements oxygen and carbon are examples of elements that are more easily excited by fast neutron inelastic scattering (n, n′) reactions. The oxygen nucleus requires neutrons having an energy threshold of 6.5 MeV to cause gamma-ray emission by (n, n′) reactions. The carbon nucleus requires neutrons having an energy threshold of 4.8 MeV to cause gamma-ray emission by (n, n′) reactions. The inelastic collision of a fast neutron with a nucleus deposits energy in the nucleus, which produces de-excitation gamma radiation that is prompt, or nearly coincident with, the production of a neutron by the generator.

Detection of all elements of interest in a sample in a reasonable time for compounds and mixtures regardless of whether the predominant mechanism of neutron interaction with a nucleus is capture or inelastic scattering requires a neutron source that impacts the sample with neutrons having a broad range of energy. The broad neutron energy spectrum ensures that both fast and slow neutrons enter the sample, and that gamma radiation from both inelastic scattering and neutron capture is observed.

Use of a neutron source having a broad range of energies was reported by The New York Times on Sep. 12, 1989. The Times reported that neutron interrogation of passenger baggage for explosives was initiated at Kennedy International Airport. The device employed is reported to weigh nearly 10 tons and use a ²⁵²Cf neutron source. The interrogation is limited to a single element: nitrogen, an element present in most explosives. It is admitted that for the device employed if the sensitivity were sufficient to identify thinly rolled plastic explosives, or an explosive mass of about one pound, the rate of false positives could reach 10 or 15 percent, and greater for smaller masses. Thus, this interrogation is less than optimal.

²⁵²Cf is a known source for slow neutrons in neutron interrogation systems. ²⁵²Cf generates neutrons continuously from spontaneous fission in excess of 2×10⁶ neutrons sec⁻¹ μg⁻¹.¹ The predominant energy of resulting neutrons is about 0.7 MeV, (slow neutrons). Thus, ²⁵²Cf is a source of slow neutrons useful for generating gamma emissions from elements that capture slow neutrons. Moreover, because a small minority of neutrons from ²⁵²Cf have energies over 2 MeV, the neutrons are not capable of exciting nuclei of carbon or oxygen in significant numbers for practical applications. Hence, using a gamma-ray spectrum to classify materials composed of carbon and oxygen excited by ²⁵²Cf is not practical. ¹ Martin, R. C. et al IRRMA '99 4^{th} Topical meeting on Industrial Radiation and Radioisotope Measurement applications, Raleigh, N.C., Oct. 3-7, 1999.

Neutron generators that produce fast neutrons are commercially available. Useful fast neutron generators may be obtained from, for example, Thermo Fisher Scientific, Colorado Springs, Colorado, USA. Typical neutron generators useful herein produce neutrons by accelerating deuterium ions into a tritium target. Generated neutrons emit in all directions i.e., isotropically from the tritium target at an energy of 14.1 MeV. Deuterium ions may be generated by a Penning ion source as is well known in the art. The deuterium ion source, and hence the D-T reactions, are switchable on and off, offering a significant practical advantage over the continuous decay of ²⁵²Cf. In addition, D-T generators are portable and have yields of from 10⁷ to 10⁹ neutrons per second.

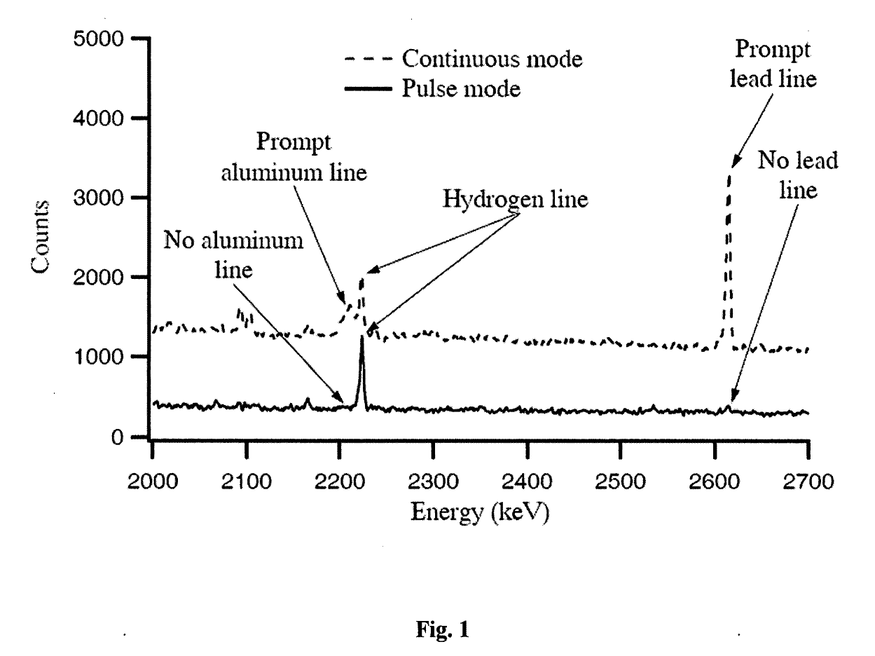

Irrespective of the use of a moderator, the energy of fast neutrons is lost by interaction of the fast neutron with its surroundings at a time on the order of 100 μsec after the fast neutron is generated. Thus if the generation and emission of 14 MeV neutrons from the D-T generator is halted, gamma rays generated from fast, inelastic reactions conclude on a timescale of less than 10 μsec after the D-T generator ceases operation. Gamma rays detected subsequent to 10 μsec may be considered as mainly resulting from neutron capture reactions. These features are illustrated in FIG. 1. The data shown on top as a dashed line was collected while both the neutron generator and detectors were operating continuously. Both fast and slow signals appear in this gamma-ray energy spectrum. The data shown on bottom as a solid line was collected using a pulsed mode of the neutron generator, where the detectors acquired data during the time that the neutron generator was not producing neutrons. Data collected in pulsed mode is from slow neutron processes, such as neutron capture. Note that the lead and aluminum lines, which are present in the dashed data and are due to a prompt reaction, are absent in the pulsed mode data.

When a neutron interacts with a ²³⁸U nucleus, the following reactions have high probability of occurring; (n, 2n), in which 2 neutrons leave the nucleus, (n, 3n), in which 3 neutrons leave the nucleus, or fission, in which two lighter elements are produced and neutrons and gamma radiation are liberated. When a 14 MeV neutron causes ²³⁸U to fission, it produces approximately 4.4 neutrons. The outgoing neutrons produced by these reactions tend to be emitted isotropically.

The principle of neutron induced fission of uranium is employed for the location of uranium ore. Suspected uranium ore is bombarded with neutrons from a neutron generator. Neutron detectors then record if neutrons having an energy characteristic of uranium are generated by the bombarded ore. See U.S. Pat. No. 3,686,503 incorporated herein by reference.

Table 1 provides Monte Carlo calculation of the number of neutrons, emitted through the top surface of a large slab of material, for selected materials in selected neutron energy bands, and the thickness of the material at which neutron emission through the top surface approximately saturates. The table shows that uranium has an advantage over other materials such as lead, iron, polyethylene, and carbon by returning a greater number of neutrons per 14 MeV neutron impact.

TABLE 1

| | | Calculated | |
|---|---|---|---|
| | | Approximate | |
| Reflector/ | | Neutron Reflection | Calculated |
| amplifier | Energy Range (keV) | Saturation | Thickness (cm) |
| Uranium | 0 keV to 1 keV | <1% | 102 |
| | 1 keV to 100 keV | 18% | 30 |
| | 100 keV to 1 MeV | 127% | 20 |
| | 1 MeV to 6 MeV | 60% | 10 |
| | 6 MeV to 14 MeV | 8% | 5 |
| | 0 keV to 14 MeV | 220% | 30 |
| Lead | 0 keV to 1 keV | <1% | 102 |
| | 1 keV to 100 keV | 12% | 102 |
| | 100 keV to 1 MeV | 72% | 41 |
| | 1 MeV to 6 MeV | 48% | 30 |
| | 6 MeV to 14 MeV | 9% | 10 |
| | 0 keV to 14 MeV | 150% | 102 |
| Iron | 0 keV to 1 keV | <1% | 102 |
| | 1 keV to 100 keV | 7% | 102 |
| | 100 keV to 1 MeV | 45% | 41 |
| | 1 MeV to 6 MeV | 26% | 20 |
| | 6 MeV to 14 MeV | 8% | 5 |
| | 0 keV to 14 MeV | 89% | 102 |
| Dirt | 0 keV to 1 keV | 8% | 41 |
| | 1 keV to 100 keV | 2% | 10 |
| | 100 keV to 1 MeV | 50% | 20 |
| | 1 MeV to 6 MeV | 13% | 20 |
| | 6 MeV to 14 MeV | 10% | 10 |
| | 0 keV to 14 MeV | 39% | 30 |
| Carbon | 0 keV to 1 keV | >16% | 102 |
| | 1 keV to 100 keV | 6% | 30 |
| | 100 keV to 1 MeV | 9% | 30 |
| | 1 MeV to 6 MeV | 15% | 20 |
| | 6 MeV to 14 MeV | 20% | 10 |
| | 0 keV to 14 MeV | 66% | 51 |
| Polyethylene | 0 keV to 1 keV | 9% | 20 |
| | 1 keV to 100 keV | 2% | 10 |
| | 100 keV to 1 MeV | 4% | 10 |
| | 1 MeV to 6 MeV | 9% | 20 |
| | 6 MeV to 14 MeV | 9% | 10 |
| | 0 keV to 14 MeV | 40% | 30 |

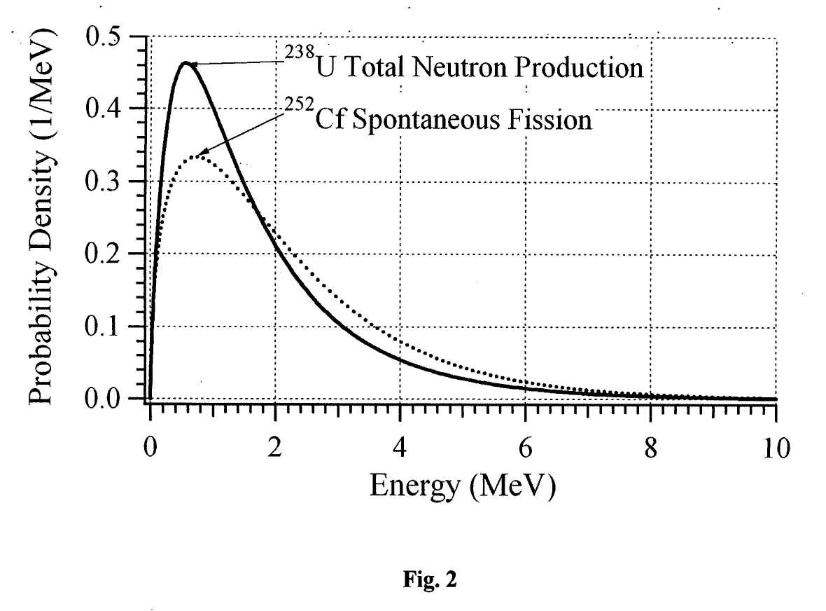

It has been found that ²³⁸U having a thickness dimension of 20 cm, emit in excess of 2 neutrons across the top surface of the reflector per 14 MeV neutron impacting the material. Of the neutrons emitted through the top, approximately 20% are in the slow neutron energy range in which the (n, γ) cross section is significant. FIG. 2 illustrates the Watt spectrum comparison of the neutron generation of ²⁵²Cf with the neutron generation of ²³⁸U exposed to 14 MeV neutrons. The data for both ²⁵²Cf and ²³⁸U is commonly available through the National Nuclear Data Center. Close resemblance of the neutron energies is demonstrated.

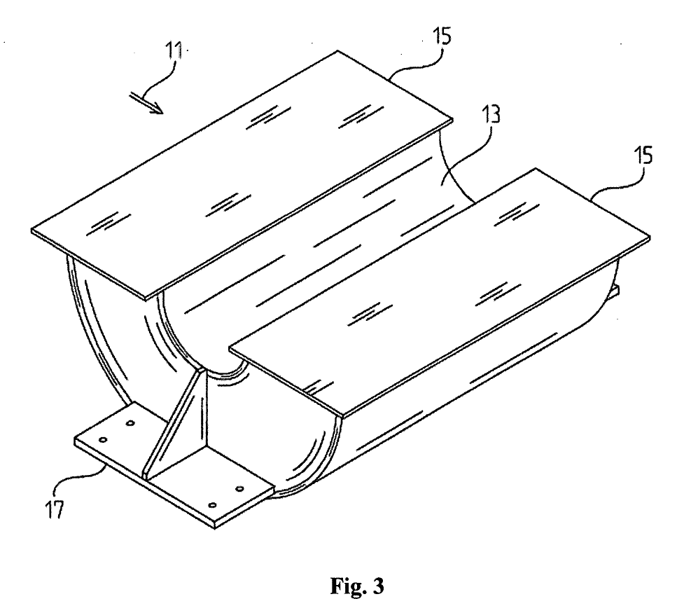

The neutrons emitted from uranium enable interrogation of samples for elements such as chlorine, fluorine, phosphorus, arsenic, and sulfur, among others. By selection of the geometric configuration of ²³⁸U, the neutron emission of the Uranium can be maximized. Commercial D-T generators are available shaped as cylinders. FIG. 3 illustrates an efficient neutron amplifier 11 shaped as a half-cylinder having a central hollowed portion 13 5 cm in radius to receive the neutron generator. Effective amplifiers will have a thickness of 10 cm. Uranium of 15 cm or even 20 cm thickness will yield a greater slow neutron flux to interrogated material.

Flanges 15 and brackets 17 facilitate incorporation of the reflector/amplifier into an interrogation apparatus.

The typical neutron die-away time in the reflector/amplifier is 1 μs, allowing it to act as a switchable on/off neutron source that provides neutrons similar to ²⁵²Cf. Some compromises may result from a desire to reduce the overall weight of the equipment. As uranium has a density of 19g/cm³, a reflector/amplifier adequate to receive a D-T neutron generator capable of producing 3×10⁸ 14 MeV neutrons/sec may be accommodated in a reflector/amplifier having an axis length of 37 cm. For the axis indicated and a 5 cm channel for a neutron generator, the weight of the uranium may be kept below 750 lbs (340 kg) for reflector/amplifier thickness of 12.7 cm.

Gamma rays emitted by excited nuclei are emitted isotropically. The emitted rays are advantageously detected by high purity germanium detectors (HPGe). When combined with appropriate data collection hardware and software as is known in the art, the data collected using HPGe detectors can be used to produce a histogram of the number of gamma rays observed as a function of energy. HPGe detectors are favored because they have a measuring energy resolution of approximately 2 keV.

The uranium reflector/amplifier emits more neutrons than impact the uranium reflector/amplifier. The described interrogation apparatus offers the further advantage of supplying fast, 14 MeV, neutrons to a material sample to be classified. As neutrons are emitted by the D-T generator in an approximately isotropic pattern, a portion of the 14 MeV neutrons generated are directed to the sample to be interrogated. These 14 MeV neutrons exceed the energy threshold to excite the nuclei of carbon, oxygen, phosphorus, sulfur, fluorine, sodium, potassium, silver, magnesium, aluminum, silicon, manganese, iron, zinc, arsenic, tin, and lead. Thus, there is here provided a single apparatus and switchable on/off neutron source capable of interrogating a material sample with both fast neutrons and with slow neutrons affording neutron interrogation for elements whose nuclei are excited by a wide range of neutron energy.

Materials to be interrogated may be contained in customary utilitarian containers, or deliberately shielded as an effort to avoid detection by neutron activation. If all neutrons were absorbed by the container or initially encountered contents, then the remainder of the contents of the container would not be interrogated. Neutron sources having a broad range of neutron energies enable good coupling of the neutrons, or high probability to excite all portions of the container and its contents. As the colliding neutrons interact through elastic collisions with nuclei, a portion of the colliding neutrons eventually arrive at an energy at which they will be captured by a nucleus resulting in the emission of gamma radiation characteristic of the element.^{2,3} By providing a broad spectrum of neutron energies the apparatus disclosed and claimed enhances greatly the signal from slow reactions within a material sample and consequent classification of the material throughout the sample. ² Choi, H. D. et. al. Database of Prompt Gamma Rays from Slow Neutron Capture for Elemental Analysis. IAEA Vienna, 2006.³National Nuclear Data Center (NNDC), Brookhaven National Laboratory, Upton, NY.

A classification system may establish a minimum threshold number of neutrons to penetrate a material sample to be considered statistically significant. If a material sample interrogated does not permit the threshold number of neutrons to penetrate the material sample, then an interrogation system may extend the interrogation time until the threshold number of penetrations is observed. Alternatively, if the sample material is shielded from the penetration of neutrons, whether deliberate or inadvertent, the system can signal that neutron interrogation is precluded, whereupon, an alternate examination may be undertaken such as physical examination of the opened container.

As noted, neutrons are a penetrating radiation capable of passing through materials to a significant depth: 14 MeV neutrons may pass through a foot of lead with little absorption. Slow neutrons are more easily stopped through absorption, but the use of a uranium neutron reflector produces a broad distribution of neutrons between the slow and fast ranges, producing a more uniform capture rate as a function of thickness and thus more complete interrogation of the sample. Gamma radiation also is penetrating radiation. Gamma radiation resulting from neutron initiated nuclear excitement has energy in the MeV range, and penetrates matter permitting detection outside the container of gamma radiation described as characteristic of the elements within the container. The use of these different penetrating forms of radiation ensures that shielding a material against detection is a difficult challenge.

Prompt neutrons occur with fission of a large nucleus into two smaller nuclei. In contrast to neutron capture events, fast fission, and prompt neutron and gamma-ray emission, occurs with no significant delay after the neutron is produced by the generator. Nuclei that capture low energy neutrons emit gamma radiation delayed for a measurable time, on the order of hundreds of microseconds (μsec) because of the slow-down collision process of the neutron with its surroundings before nuclear capture. Thus, after the prompt neutron and gamma-ray emission due to interactions with 14 MeV generated neutrons, gamma radiation from the nuclei of elements that capture slow neutrons can be detected.

### Materials Classification

In most circumstances the chemical bonding of the elements within the material determines a materials interactions. Neutron elemental analysis does not measure these materials (chemical) bonding relationships. For this reason the utility of the scanner is not to strictly identify a material but to classify a material by differentiating and classifying a material within a limited set of possible materials that might be presented to the scan from a sub-world of the complete universe of all the materials. Neutron interrogation differentiates materials only within this sub-world and places the interrogated material into a sub-class of materials within the sub-world.

It is advantageous to approach the problem of interrogation of closed containers by classification of the contents. For example, in the case that the sub-world consists of the set elements that are simply bonded then by taking elemental ratios, the measurement of

$$[ \frac{H}{O} ] = 2 ,$$

for a material can be classified as water as opposed to hydrogen peroxide. While this is not universal or a general conclusion, in the context of the sub-world being searched this is a valid conclusion. Within another sub-world in which pure gas mixtures are being searched, it would be concluded that an explosive gas mixture is present. This example illustrates that within a context or sub-world, the elemental ratios or reduced stoichiometric parameters can be found. However the conclusion, or whether or not a conclusion can be reached, depends on the sub-world being searched.

The sub-world is a set of the materials to be sorted or differentiated into classes. The elemental makeup of each material is the input to the differentiation process. Each material can be represented as a set of elemental quantities:

Mᵢ={χ₁,χ₂,χ₃ . . . χₙ},

where χᵢ is the i^{th} element, and n is the number of elements that are used to classify the i^{th} material. Each element in turn is defined by a set of interrogation parameters:

χᵢ={(Lᵢ¹, . . . Lᵢ^{k}^{ᵢ}),(Sᵢ¹, . . . Sᵢ^{k}^{ᵢ}),(Dᵢ¹, . . . , Dᵢ^{k}^{ᵢ})}

where Sᵢ^{k}^{ᵢ} is the strength of the k^{th} peak in the gamma-ray energy spectrum associated with i^{th} element, Lᵢ^{k}^{ᵢ} is the gamma-ray energy of the k^{th} peak in the gamma-ray spectrum associated with i^{th} element, and Dᵢ^{k}^{ᵢ}, is the detection modality for the k^{th} peak in the gamma spectrum associated with the i^{th} element.

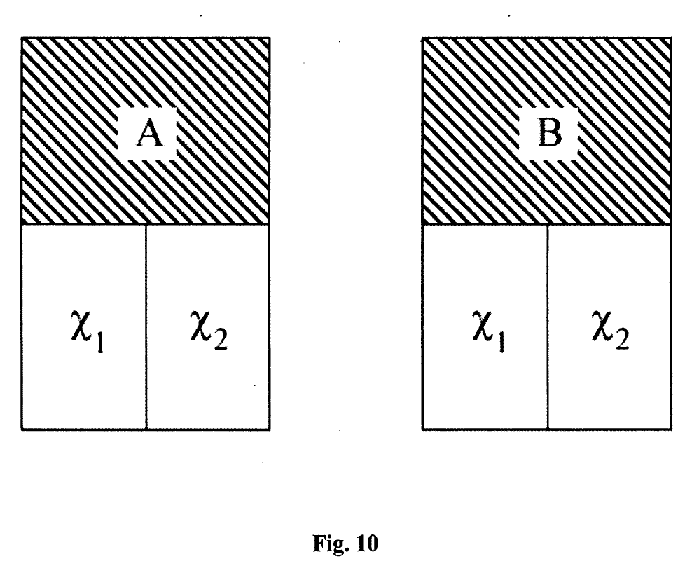

It should be noted that not all the elements that occur in the materials of the sub-world are used for materials classification and differentiation. A description of a material as defined above is not a complete description. Because of this, some materials are not uniquely differentiated but are grouped into classes of similar materials. FIG. 10 shows an example of two materials, composed of three elements. The first material contains 25% of the element χ₁, 25% of the element χ₂, and 50% of element A, while the second material consist of 25% of the element χ₁, 25% of the element χ₂, and 50% of element B. Elements A and B are not in the list of identified elements, therefore these two materials will be recognized as members of one sub-class. This level of differentiation is useful when the presence of elements χ₁ and χ₂ is sufficient for the conclusive differentiation of a particular class of materials from all groups within the sub-world. This treatment is especially useful when the detection of element(s) A and/or B requires special detection modalities which may slow down the differentiation process and significantly worsen the system's throughput.

### Steps Required to Develop Differentiation and Classification Subgroups

The steps required to develop the parameters by which the sub-world of materials can be characterized and classified into subgroups are:

(1) All the groups of the materials or individual materials of interest have to be defined. Groups are formed on the basis of similar elemental content.
(2) For each of the groups of materials defined, identification of which individual elements making up the members of the group are necessary for differentiation from other groups within the sub-world.
(3) All the elements necessary for classification are analyzed for the presence of neutron-induced spectral lines and their production mechanisms. Not all the elements present in the materials need be included in the analysis. Only those required for differentiation within the sub-world will be used.
(4) The expected quantity of material is defined in order to establish the scan time required for adequate differentiation.

### Transformation of Gamma Ray Observation to Elemental Quantities

One of the necessary steps to differentiate materials is to determine the ratio of elements of interest from the scanned sample. This is accomplished by first searching the collected gamma-ray spectrum for the energy lines corresponding to the elements of interest, which are fitted with Gaussian-like functions to obtain the number of counts in each line.

One class of characteristic gamma-ray spectral lines considered for elemental detection are produced in fast neutron inelastic scattering reactions. In this case the quantity of the i^{th} element χᵢ is linearly proportional to the number of counts Aᵢ in the spectral peak(s) corresponding to the i^{th} element. The phenomenological proportionality constant αᵢ depends on the corresponding reaction cross-section, properties of the sample, properties of the detectors used and operation modality of the scanner:

χᵢ=αᵢAᵢ.

The response linearity is due to the following reasoning. Inelastic scattering reactions as a group, have a threshold incident neutron energy of ˜1 MeV and greater. The characteristic reaction length for inelastic scattering reactions for all the material samples presented to the scanner is approximately an order of magnitude larger than the mean free path of neutrons. An object is considered thin (˜20 cm water equivalent thick) if its thickness is less than the sample's inelastic scattering reaction length. Therefore, the probability for a fast neutron to encounter more than one inelastic interaction in a thin sample before exiting the sample is small, and the system response is linear.

Interrogated materials are classified according to the ratio of their elements. For this reason the analysis forms

$$\begin{matrix}[ \frac{{χ}_{i}}{{χ}_{j}} ] = \frac{{α}_{i} {A}_{i}}{{α}_{j} {A}_{j}} \\ = {β}_{ij} \frac{{A}_{i}}{{A}_{j}}\end{matrix}$$

which is a linear relationship between the observed signals for each element and their stoichiometric ratio within the sample. This ratio is also first order free of the geometrical properties of the sample, many properties of the detectors used and operation modality of the scanner as these corrections a similar for each element and as such cancel.

Another class of characteristic gamma-ray spectral lines considered for elemental detection are produced in neutron capture reactions. The neutron capture reaction does not have an energy threshold as does inelastic neutron scattering. On the contrary, the cross section for neutron capture for room temperature, or thermal neutrons with energies of ˜0.02 eV can be orders of magnitude larger than the neutron capture cross section for fast neutrons with energies greater than 1˜MeV. For this reason, the neutron mean free path for thermal neutrons is less than the characteristic length scale of the sample for hydrogenated materials. Therefore, the low energy neutrons, energy shifted within the neutron guide are captured in the sample so that for these neutrons the sample appears “black”. In the case of a uniform sample, for an element with signature gamma lines due to neutron capture, the ratio of these elements is proportional to the ratio of the number of counts, in the corresponding lines:

$$\begin{matrix}[ \frac{{χ}_{i}}{{χ}_{j}} ] = \frac{{α}_{i} {A}_{i}}{{α}_{j} {A}_{j}} \\ = {β}_{ij} \frac{{A}_{i}}{{A}_{j}} .\end{matrix}$$

Again, this ratio is also to first order free of the geometrical properties of the sample, many properties of the detectors used and operation modality of the scanner as these corrections are similar for each element and as such cancel.

Finally the two classes of neutron interactions, slow and fast, within the sample can be related and the corresponding elemental ratios can be found. This is because (1) the geometrical properties for the samples presented to the scanner have similar surface to volume ratios and (2) neutron capture events occur both in the surface layer of the material due to the low energy portion of the neutron spectrum and within the volume of the material due to the broadband neutron energy spectrum from the uranium reflector/amplifier, neutron guide, and neutrons scattered by light elements such as hydrogen to lower energies which occur throughout the entire volume of the sample and (3) inelastic neutron scattering events occur throughout the entire volume of the sample. Elastic scattering of neutrons on hydrogen is such that the outgoing neutron has a constant probability of having any energy between zero and the incoming neutron energy. Therefore hydrogen can serve as a reference for both slow neutron elemental ratios and fast neutron elemental ratios because it shifts a portion of the high energy neutron flux to low energies, which it samples by capturing. We have observed that the ratio of the strengths of two signals, the “fast” and “slow” can be used to determine the elemental ratios in the following way:

$$\begin{matrix}[ \frac{{χ}_{slow}}{{χ}_{fast}} ] = [ \frac{{χ}_{slow}}{{χ}_{hydrogen}} ] [ \frac{{χ}_{hydrogen}}{{χ}_{fast}} ] \\ = {α}_{slow - hydrogen} {α}_{hydrogen - fast} \frac{{A}_{slow}}{{A}_{fast}} ,\end{matrix}$$

in the presence of hydrogen. If hydrogen is not present then the relationship between the two elements is fixed by the known broadband energy flux within the scanner, as hydrogen is special in its ability to shift the neutron flux.

In the case that an element with extremely large neutron capture cross section exists within the sample, such as chlorine, then presence of hydrogen can enhance the signal of the strong capture element and the other capture elements including hydrogen will have their signal strength reduced. In this case we observe that the stoichiometric ratios can be determined in the following way:

$$\begin{matrix}[ \frac{{χ}_{slow}}{{χ}_{fast}} ] = [ \frac{{χ}_{Cl}}{{χ}_{H}} ] [ \frac{{χ}_{H}}{{χ}_{fast}} ] [ \frac{{χ}_{slow}}{{χ}_{Cl}} ] \\ = {α}_{Cl - H} {α}_{slow - Cl} {α}_{H - fast} \frac{{A}_{slow}}{{A}_{fast}} ,\end{matrix}$$

where it is approximated that the largest neutron capture cross-section is nearly equivalent to the sum of all macroscopic cross-sections of elements within the sample. Materials classification, grouping and identification is performed based on the elemental stoichiometric ratios of the material. It is convenient to consider the elemental stoichiometric ratio ξᵢ, rather than χᵢ and χᵢ,

$${ξ}_{i} = [ \frac{{χ}_{i}}{{χ}_{j}} ] .$$

Once the elemental ratios have been found, the scanned material is assigned a point in a multidimensional hyperspace using the coordinates ξᵢ. The classification and identification materials is then performed by dividing the hyperspace into sets of volumes so that each volume contains one material or one group of materials. The distance between separate classes determines the measuring accuracy required to place a scanned item within the hyperspace.

There are two reasons for using groups of similar materials rather than identifying single materials:

(1) The statistical accuracy of the measurement in the time allowed for the scan may not be sufficient for individual materials identification, but may be sufficient for identification of a material as a member of a group.
(2) Identification of individual materials within the group may not be required for the purposes of the application.

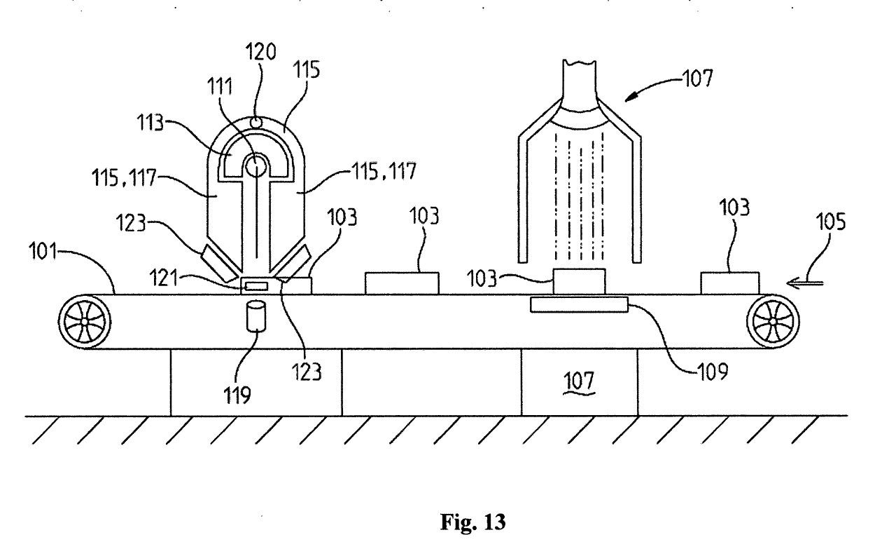

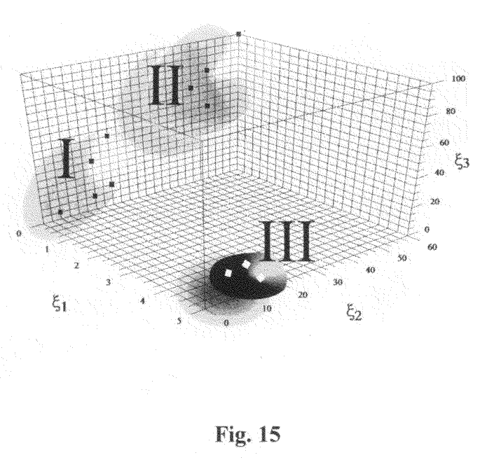

An example of the classification of materials into 3 classes is shown in FIG. 15. In the figure Group III is easily separated from the rest of the materials by the presence of element 1 while Groups I and II are separated by different amounts of elements 2 and 3 in the materials. An unfortunate fact of current events includes terrorist activity by disaffected individuals and groups. Popular acts among the disaffected include transport and discharge of contraband where innocents congregate including air travel. Practical application of the instant invention may be found in the examination of travelers' baggage for contraband. One useful embodiment combines neutron interrogation with x-ray interrogation. As illustrated by FIG. 13, baggage is first examined by x-ray. An operator examines the x-rayed contents of a bag on a screen. If no contents of concern are detected, then the bag is passed through. If an item within the container cannot be cleared, the item(s) may be subjected to neutron interrogation as described and claimed herein.

Looking specifically to FIG. 13, there is illustrated a conveyor (101) for advancing baggage items (103). The direction of travel (105) of the conveyor first exposes the baggage items to inspection in an x-ray interrogation system (107). X-ray penetration through the baggage is registered on a detector (109) which is communicated to a screen for examination by an operator.

If the operator cannot conclude on the basis of x-ray interrogation that the materials within the baggage are innocuous, then the operator may indicate that the entire container, or a portion thereof, be subjected to neutron interrogation as herein described and claimed. Neutron interrogation apparatus includes a D-T generator (111), a uranium reflector/amplifier (113), and appropriate shielding (115) which may also serve as a guide (117) to direct neutrons in the direction of the baggage. A transmission neutron detector (119) and a reference neutron detector (120) are used to register neutron penetration through the baggage, and the specific item therein of interest (121), as identified by x-ray interrogation. If insufficient neutrons are penetrating through the sample, the neutron production in the generator may be increased or the interrogation time extended until sufficient neutrons are observed by the monitor.

Gamma rays characteristic of the elements comprising the specific item of interest are detected by high purity germanium detectors (123).

Classification of an interrogated material within a container or baggage is accomplished by measuring the ratio of elements as determined from the gamma-ray signatures of the neutron excited nuclei. Comparisons of the elemental gamma-ray signatures, and calculation of ratios of elements and classification of the ratios into subclasses of materials of interest can be accomplished by numerical manipulations well suited to computer calculations.

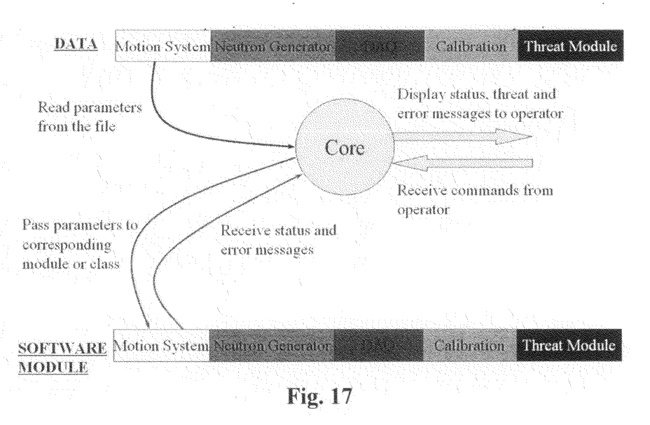

An architecture suitable for material classification and control functions necessary for neutron interrogation of containers/baggage, to develop the gamma-ray spectra of interrogated materials, calculate the elemental ratios of elements of interest sufficient to classify the contents according to ratios of elements, and determine if the content materials of the container/baggage is innocuous or are warranting further investigation could have the design and modules of FIG. 17.

Further investigation may include additional neutron interrogation for extended neutron exposure time, and further its associated elemental ratio calculation. Further neutron interrogation may be focused on specific portions of the container contents and, if warranted, opening of the container for physical inspection.

### EXAMPLES

### Example 1

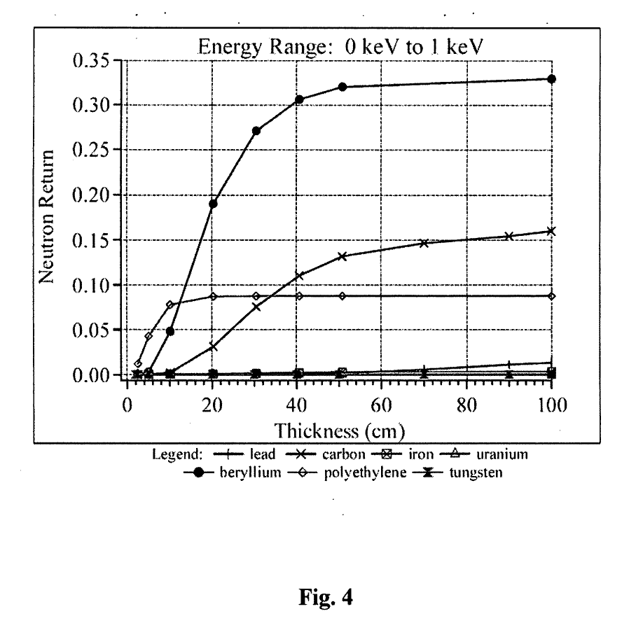

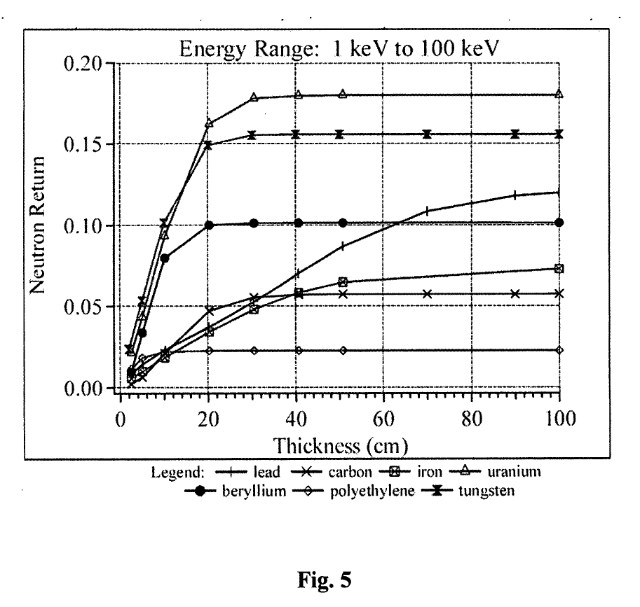

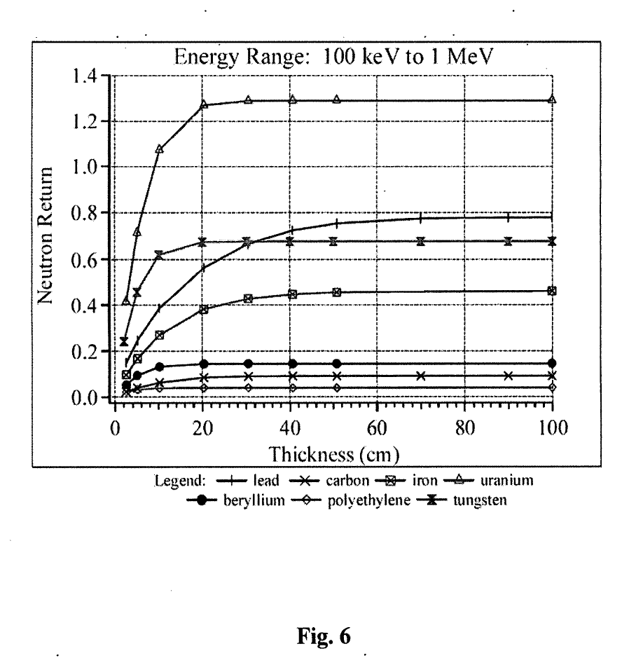

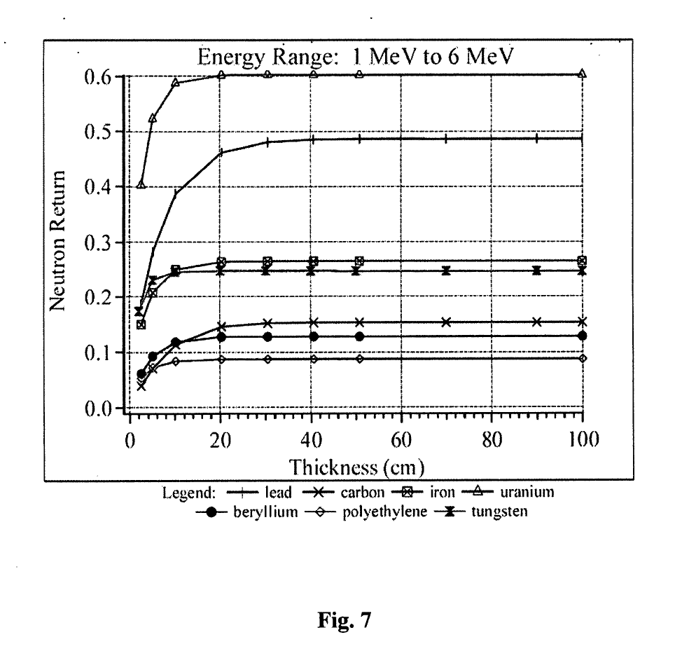

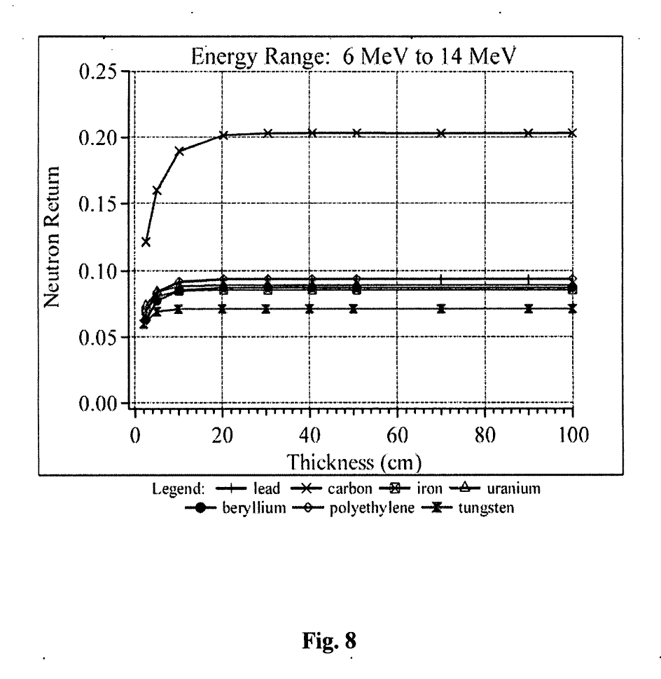

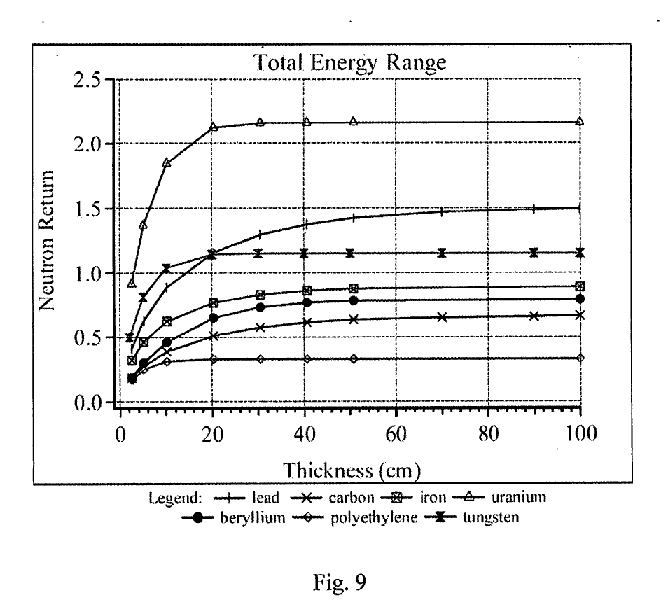

The materials lead, carbon, iron, uranium, beryllium, polyethylene and tungsten subjected to simulated exposure to 14 MeV neutrons in a computer simulation using Monte Carlo N-Particle transport code (MCNP) to determine the number of neutrons returned by the material samples. The simulation assumed rectangular material samples two meters square of a thickness indicated were exposed to 14 MeV neutrons from a D-T generator 5 cm above the center of the reflector. Detection was segmented into five energy ranges as indicated in FIGS. 4-9. The simulation projected that in the slow neutron range of interest, from 1 keV to 100 keV, that Uranium is most effective in returning neutrons. Also noted for Uranium is the return of in excess of two neutrons for each neutron impacting the reflector.

### Example 2

Using a D-T neutron generator several materials were evaluated as neutron reflectors/amplifiers. Apparatus employed included a MF-Physics A-325 D-T neutron generator operated to produce 8×10⁷ neutrons/sec. Produced gamma radiation was detected by Ortec PopTop HPGe detectors, Ortec DSPEC Plus digital processors, and Ortec X-cooler II refrigeration units. Appropriate safety shielding was provided. Depleted uranium, lead, and graphite were evaluated, and compared to data collected with no material.

Gamma radiation from a 2 liter sample of distilled water was evaluated with each material. To reduce interference from the surroundings, the sample was elevated 173 cm (68 inches) above a concrete floor. The material was supported by a 71 cm×71 cm×1.3 cm (28 in×28 in×½ in) steel plate with a centered hole 37 cm×37 cm (14.5 in×14.5 in) therein to reduce neutron flux attributable to the supporting plate. The plate was elevated 37 cm (14.5 in) above the concrete floor on rectangular aluminum legs 10×10 cm (4 in×4 in). The legs were stabilized by fixing their ends to steel plates 30.5 cm×30.5 cm×1 cm (12 in×12 in×0.4 in). The D-T generator was located 47.6 cm from the distilled water sample.

The graphite was comprised of bricks. Hence necessary support for the blocks was provided by aluminum grating on the described steel plate having a thickness of 3.8 cm (1.5 in).

A first HPGe detector was located 132 cm (46.5 in) from the center of the distilled water sample and at the height of the sample. Two additional HPGe detectors were located 20 cm (7.9 in) alongside the first detector. The detectors were shielded to limit detected radiation to that generated by the distilled water sample.

For detection of hydrogen, the D-T generator was operated in pulsed mode with a frequency of 10 kHz at a duty factor of 15%. The combined pulse, pause, and detection interval had a duration of 100 μs pulse length. The source pulse occurred from 0 to 15 μs. The gamma-ray detectors collected data from the 25 μs to 100 μs, whereupon the sequence repeated for a period of 5 minutes.

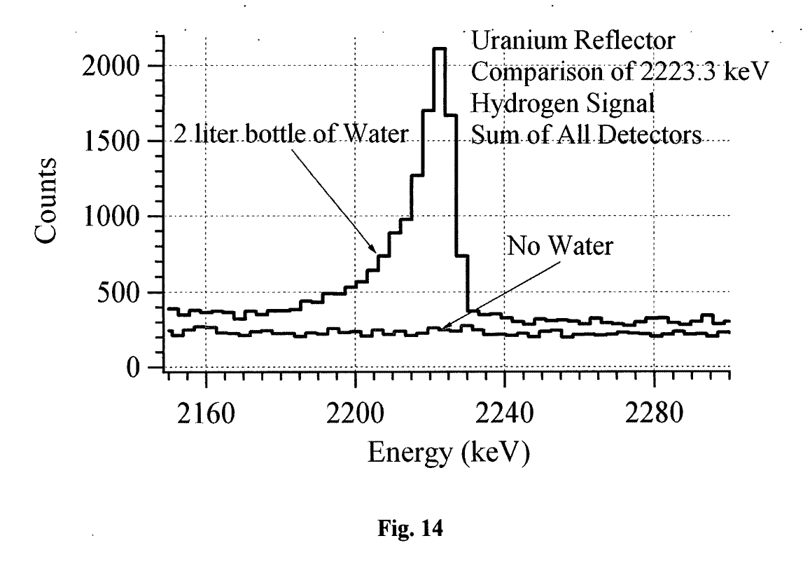

The level of any background hydrogen gamma-ray emission was determined by gamma-ray signal measurement with no water present. FIG. 14 is a histogram of the gamma-ray energy utilizing a uranium reflector with and without a water sample.

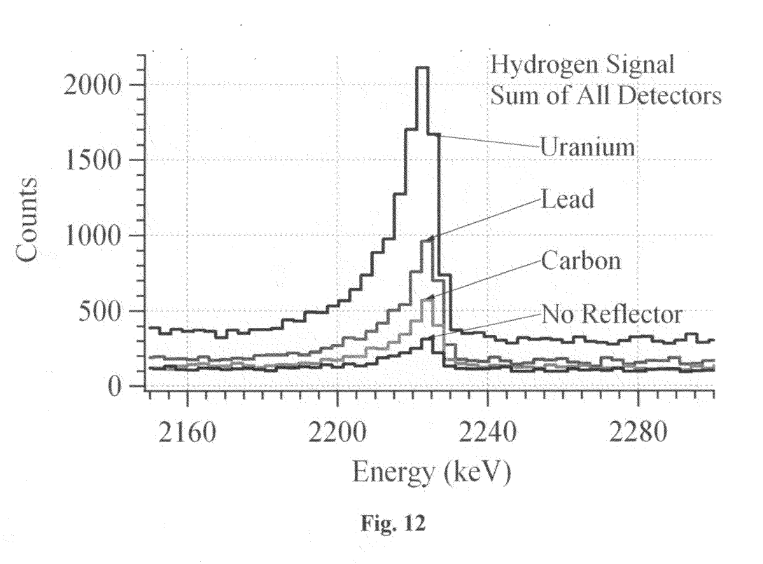

Repeating the test with uranium, lead and carbon generated the histogram of FIG. 12 for the three materials and the no material case. The histogram establishes that for the 2223.3 keV gamma-ray emission of hydrogen the uranium reflector generates more than twice as many neutron capture events than lead, the next highest efficient material.

### Example 3

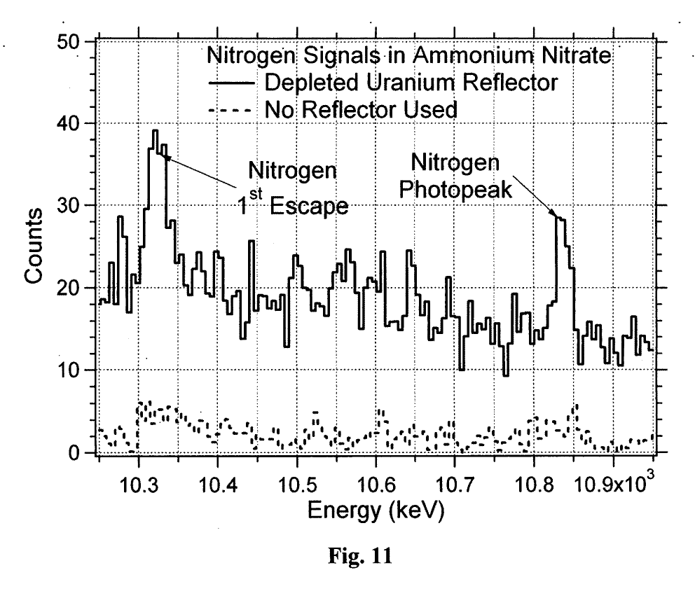

Gamma radiation from a 1 liter sample of ammonium nitrate was evaluated with and without the uranium reflector. The sample was elevated 62.7 cm (24.7 in) above the D-T generator. A paraffin moderator 15 cm (6 in) thick, with an opening 15 cm×30.5 cm (6 in×12 in) was used to further reduce the energy of neutrons produced in the generator and reflector/amplifier. The produced radiation was detected by two Ortec PopTop HPGe detectors which were appropriately shielded and placed adjacent to the sample data was collected both with and without the uranium reflector/amplifier in pulsed mode, as described in Example 2. The material was interrogated with and without a uranium reflector/amplifier configured as illustrated by FIG. 3. A histogram of the gamma rays from the sample is presented as FIG. 11.

### Example 4

A 2 liter polyethylene container was interrogated by neutrons as in Example 3 using the uranium reflector, but without the paraffin guide. The container was interrogated in an empty condition and filled with water. A histogram of the gamma rays from the container, and the container while filled is presented as FIG. 14.

### Example 5

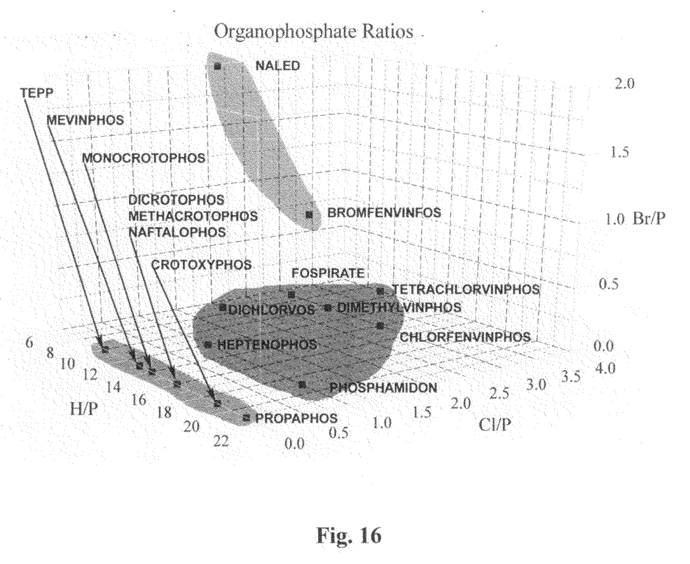

The classification process making use of hyperspace is applied to organophosphate insecticides also containing bromine and chlorine and those that do not also contain either element. FIG. 16 shows the organophosphates classified according halogen ratio.

The forgoing description, figures and examples are illustrative, not limiting, of the claimed invention and its utility.

1. A source for slow neutrons comprising
a deuterium-tritium neutron generator and a reflector/amplifier.

2. The slow neutron source of claim 1 wherein the reflector/amplifier is selected from the group consisting of carbon, lead, beryllium, uranium, or a combination thereof.

3. The slow neutron source of claim 1 that is switchable on and off.

4. The slow neutron source of claim 1 that also is a source of fast neutrons.

5. The slow neutron source of claim 2 wherein the reflector/amplifier is uranium.

6. The slow neutron source of claim 5 wherein the uranium is depleted uranium.

7. The slow neutron source of claim 1 that is capable of exciting the nuclei of the group consisting of carbon, oxygen, phosphorus, sulfur, fluorine, sodium, potassium, silver, magnesium, aluminum, silicon, manganese, iron, zinc, arsenic, tin, and lead with fast neutrons.

8. The slow neutron source of claim 1 having detectors for gamma rays emitted by excited nuclei.

9. The slow neutron source of claim 8 wherein the detectors are high purity germanium detectors.

10. The slow neutron source of claim 1 wherein the deuterium-tritium generator produces from 10⁷ to 10⁹ neutrons per second.

11. Classification of unknown material comprising:
interrogation of the material with fast and slow neutrons generated according to claim 1;
detecting the gamma radiation emitted from the nuclei of the interrogated material;
detecting the elements present from gamma radiation characteristic of the element;
classification of the interrogated material by ratios of elements present therein.

12. The classification of claim 11 wherein the fast neutrons impact the unknown material in a pulsed sequence.

13. The classification of claim 11 wherein the slow neutrons impact the unknown material in a pulsed sequence.

14. The classification of claim 11 wherein both fast and slow neutrons impact the unknown material in pulsed sequence.

15. Classification according to claim 11 of travelers' baggage.

16. Classification of baggage according to claim 15 in combination with x-ray interrogation.

17. The classification of claim 11 wherein the ratios of elements present in the material to be classified is calculated with the aid of a computer.

18. Classification of unknown material comprising:
interrogation of the material with fast and slow neutrons generated according to claim 5;
detecting the gamma radiation emitted from the nuclei of the interrogated material;
detecting the elements present from gamma radiation characteristic of the element;
classification of the interrogated material by ratios of elements present therein.

19. Classification of travelers' baggage according to claim 18 in combination with x-ray interrogation.

20. Classification of travelers' baggage according to claim 19 wherein the wherein the ratios of elements present in the material to be classified is calculated with the aid of a computer.
